(19) United States
(12) Patent Application Publication
(10) Pub. No.: US 2019/0384103 A1
(43) Pub. Date: Dec. 19, 2019

(54) CF SUBSTRATE, METHOD FOR MANUFACTURING CF SUBSTRATE, AND METHOD FOR MEASURING ORIENTATION ANGLE OF ORIENTATION FILM

(71) Applicant: Wuhan China Star Optoelectronics Technology Co., Ltd., Wuhan, Hubei (CN)

(72) Inventors: Weidong HOU, Wuhan, Hubei (CN); Kaiming LO, Wuhan, Hubei (CN)

(21) Appl. No.: 15/570,995

(22) PCT Filed: Oct. 19, 2017
(86) PCT No.: PCT/CN2017/106822

§ 371 Date: Oct. 31, 2017

(30) Foreign Application Priority Data
Aug. 25, 2017 (CN) 201710744069.9

(51) Int. Cl. G02F 1/1335

(52) U.S. Cl. CPC G02F 1/133516; G02F 1/133512

(57) ABSTRACT

A CF substrate, a method for manufacturing the CF substrate, and a method for measuring the orientation angle of an orientation film are provided in the disclosure. The method for manufacturing the CF substrate of the disclosure forms a plurality of recesses in the non-display region of the CF substrate such that after an orientation film is subsequently coated on the plurality of recesses, the orientation angle of the orientation film can be directly measured at the plurality of recesses. The CF substrate of the disclosure is manufactured by using the described method. It facilitates simplifying the method for measuring the orientation angle of the orientation film. The method for measuring the orientation angle of the orientation film of the disclosure includes forming the orientation film on the described CF substrate, and directly measuring the orientation angle of the orientation film at the plurality of recesses.

### FIELD OF THE DISCLOSURE

The disclosure relates to a display technical field, and more particularly to a color filter (CF) substrate, a method for manufacturing the CF substrate, and a method for measuring the orientation angle of an orientation film.

### BACKGROUND

With the development of display technology, liquid crystal display (LCD) and other planar display devices have advantages including high quality, power saving, thin body and wide application. Accordingly, they are widely used in mobile phones, televisions, personal digital assistants, digital cameras, notebook computers, desktop computers and other consumer electronics products, and become the mainstream display devices.

Most liquid crystal display devices on the current market are backlight-type liquid crystal display devices, comprising a liquid crystal panel and a backlight module. The working principle of the liquid crystal panel is placing liquid crystal molecules between two parallel glass substrates. There are multiple vertical and horizontal small wires between the two glass substrates. Driving voltage is applied to control rotation directions of the liquid crystal molecules, for refracting light from the backlight module to generate images.

In general, a liquid crystal display panel is composed of a color filter (CF) substrate, a thin film transistor (TFT) substrate, liquid crystal (LC) sandwiched between the CF substrate and the TFT substrate, and sealant. The fabrication process generally includes front-end array processes (thin film, photolithography, etching and stripping), middle-end cell processes (attaching the TFT substrate and the CF substrate), and back-end module assembly processes (laminating driving IC and a printed circuit board). In the fabrication process, the front-end array processes mainly form the TFT substrate so as to control the movement of liquid crystal molecules. The middle-end cell processes mainly add LC between the TFT substrate and the CF substrate, The back-end module assembly processes mainly laminate the driving IC and integrate the printed circuit board so as to drive the liquid crystal molecules to rotate and display images.

In the liquid crystal display panel, the CF substrate plays a key role in the display of color images. The CF substrate usually includes a base substrate, a black matrix, and a color photoresist layer that are arranged in order from bottom to top. In the LC cell processes, an orientation film usually needs to be formed on the CF substrate. Since the orientation angle of the orientation film has a significant influence on the optical performance of the liquid crystal display panel, it is usually necessary to measure the orientation angle so as to confirm whether it is in the proper range or not. The described method for measuring the orientation angle of an orientation film usually use the principle of light reflection. Color structural layers, such as a black matrix and a color photoresist layer, are disposed on the CF substrate and would easily affect light reflection. As a result, the measurement cannot be performed directly on the CF substrate. As shown in FIG. 1, the conventional method for measuring the orientation angle of an orientation film generally includes: forming multiple orientation films 200 spaced apart on the white glass substrate 100 on the basis of the method for forming an orientation film on the CF substrate; selecting multiple measuring points 300 on one or more of the orientation films 200; and measuring the orientation angle of the orientation films 200 at the measuring points 300. The measured orientation angle is the orientation angle of the orientation film on the CF substrate. However, this method is indirect measurement, so the measurement results are not accurate enough. The real-time monitoring of products in the fabrication process cannot be achieved. Defect of batch products easily occurs.

### SUMMARY

An objective of the disclosure is providing a method for manufacturing a CF substrate, which is able to simplify the method for measuring the orientation angle of an orientation film and enhance the measurement accuracy.

Another objective of the disclosure is providing a CF substrate, which is able to simplify the method for measuring the orientation angle of an orientation film and enhance the measurement accuracy,

Yet another objective of the disclosure is providing a method for measuring the orientation angle of an orientation film without individually manufacturing a measuring substrate. The measurement method is simple, The measurement accuracy is high. It facilitates realizing the real-time monitoring of the orientation angle of the orientation film in the fabrication process. The batch products are prevented from defect.

To achieve the afore-mentioned objectives, the disclosure first provides a method for manufacturing a CF substrate, including the following steps:

Step 1, providing a base substrate. The base substrate includes a display region and a non-display region disposed around the display region.

A multilayer-stacked structural layer is formed on the base substrate, An area corresponding to the non-display region includes a plurality of through holes disposed in the multilayer-stacked structural layer.

Step 2, forming a flat layer on the multilayer-stacked structural layer and the base substrate. The plurality of through holes is surrounded by the flat layer. The surface of the flat layer corresponding to the plurality of through holes forms a plurality of recesses.

The multilayer-stacked structural layer includes at least a first structural layer disposed on the base substrate and a second structural layer disposed on the first structural layer, The first structural layer and the second structural layer are any combination of a black matrix and a color photoresist layer.

In the step 1, the method for forming the plurality of through holes is, during the formation of the multilayer-stacked structural layer, forming via holes in each structural layer. The plurality of via holes corresponds to each other such that the via holes of the multilayer-stacked structural layer are connected to each other to form the through holes.

The opening shape of the recesses is a rectangle. The length of the rectangle is 5 mm˜10 mm.

The depth of the recesses is 10000 Å˜50000 Å.

The disclosure further provides a CF substrate, including a base substrate, a multilayer-stacked structural layer disposed on the base substrate, and a flat layer on the multilayer-stacked structural layer.

The base substrate includes a display region and a non-display region disposed around the display region. An area corresponding to the non-display region includes a plurality of through holes disposed in the multilayer-stacked structural layer. The plurality of through holes is surrounded by the flat layer. The surface of the flat layer corresponding to the plurality of through holes forms a plurality of recesses.

The multilayer-stacked structural layer includes at least a first structural layer disposed on the base substrate and a second structural layer disposed on the first structural layer. The first structural layer and the second structural layer are any combination of a black matrix and a color photoresist layer.

In the multilayer-stacked structural layer, each structural layer includes via holes corresponding to each other such that the via holes of the multilayer-stacked structural layer are connected to each other to form the through holes.

The opening shape of the recesses is a rectangle. The length of the rectangle is 5 mm˜10 mm.

The depth of the recesses is 10000 Å˜50000 Å.

The disclosure further provides a method for measuring the orientation angle of an orientation film, including: providing the CF substrate as described above; forming an orientation film on the flat layer of the CF substrate and covering the plurality of recesses; and using an orientation film measuring instrument to measure an orientation angle of the orientation film. The orientation film measuring instrument emits light to a portion of the orientation film located in the recesses and receives the reflected light. The orientation angle of the orientation film is measured by using the principle of light reflection.

The beneficial effects of the disclosure: the method for manufacturing a CF substrate of the disclosure forms a plurality of recesses in the non-display region of the CF substrate such that after an orientation film is subsequently coated on the plurality of recesses, the orientation angle of the orientation film can be directly measured at the plurality of recesses. The CF substrate of the disclosure is manufactured by using the described method. It facilitates simplifying the method for measuring the orientation angle of the orientation film. The method for measuring the orientation angle of the orientation film of the disclosure includes forming the orientation film on the described CF substrate, and directly measuring the orientation angle of the orientation film at the plurality of recesses. Since a flat layer is disposed under the orientation film at the plurality of recesses, the measurement of the orientation angle of the orientation film is prevented from being affected by structural layers such as a color photoresist layer and a black matrix. The flat layer is transparent and has smooth surface, It has extremely small influence on the measured result of the orientation angle of the orientation film. Compared with the prior art, the disclosure does not need to reconstruct a measuring substrate. The method for measuring the orientation angle of the orientation film is simplified. The measurement accuracy is improved. Meanwhile, the real-time monitoring of the orientation angle of the orientation film in the fabrication process is realized. The batch products are prevented from defect.

The following detailed description and accompanying drawings in the disclosure are provided for further understanding of the features and technical aspects of the disclosure. However, the drawings are provided only for the purpose of reference and illustration, and are not intended to limit of the disclosure.

### BRIEF DESCRIPTION OF THE DRAWINGS

The technical aspects and other advantageous effects of the disclosure will be apparently clear according to the following detailed description of specific embodiments of the disclosure with the accompanying drawings. In the figures:

FIG. 1 is a schematic view of a conventional method for measuring the orientation angle of an orientation film;

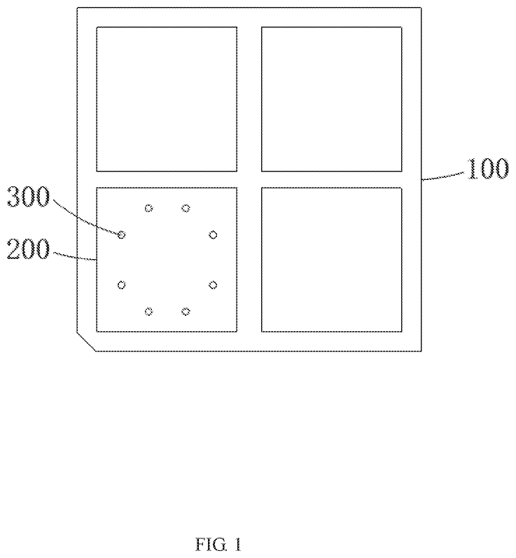

FIG. 2 is a flow chart of a method for manufacturing a CF substrate of the disclosure;

FIG. 3 is a schematic view of the step 1 of the method for manufacturing a CF substrate of the disclosure;

FIG. 4 is a schematic view of the step 2 of the method for manufacturing a CF substrate of the disclosure and shows a cross-sectional view of the CF substrate of the disclosure;

FIG. 5 shows a top view of a CF substrate of the disclosure; and

FIG. 6 is a schematic view of a method for measuring the orientation angle of an orientation film of the disclosure.

### DETAILED DESCRIPTION OF PREFERRED EMBODIMENTS

For further illustrating the technical means of the disclosure and the effects thereof, the disclosure will be described in detail with reference to preferred embodiments and the accompanying drawings as follows.

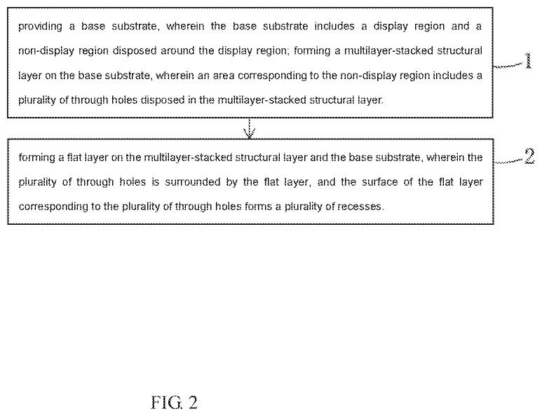

Referring to FIG. 2, the disclosure first provides a method for manufacturing a CF substrate, including the following steps:

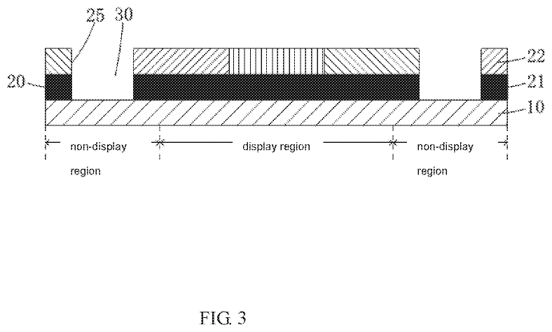

Step 1, as shown in FIG. 3, providing a base substrate 10. The base substrate 10 includes a display region and a non-display region disposed around the display region.

A multilayer-stacked structural layer 20 is formed on the base substrate 10. An area corresponding to the non-display region includes a plurality of through holes 30 disposed in the multilayer-stacked structural layer 20.

Specifically, in the step 1, the method for forming the plurality of through holes 30 is, during the formation of the multilayer-stacked structural layer 20, forming via holes 25 in each structural layer 20. The via holes 25 correspond to each other such that the via holes 25 of the multilayer-stacked structural layer 20 are connected to each other to form the through holes 30.

Specifically, the base substrate 10 is a glass substrate.

Specifically, the multilayer-stacked structural layer 20 includes at least a first structural layer 21 disposed on the base substrate 10 and a second structural layer 22 disposed on the first structural layer 21. The first structural layer 21 and the second structural layer 22 are any combination of a black matrix and a color photoresist layer.

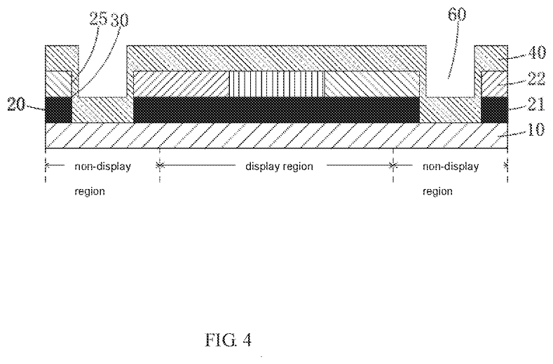

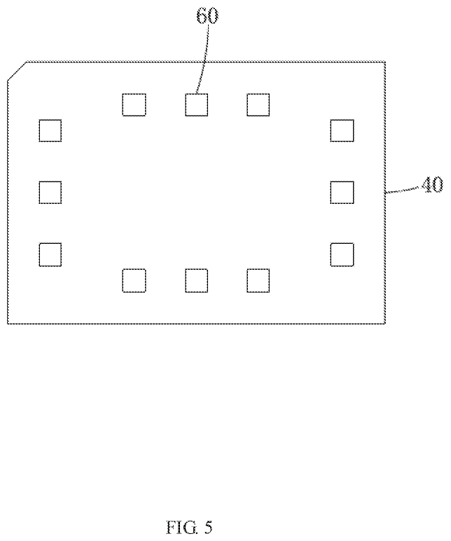

Step 2, as shown in FIG. 4 and FIG. 5, forming a flat layer 40 on the multilayer-stacked structural layer 20 and the base substrate 10. The plurality of through holes 30 is surrounded by the flat layer 40. The surface of the flat layer 40 corresponding to the plurality of through holes 30 forms a plurality of recesses 60.

Specifically, the flat layer 40 is a transparent organic material.

Specifically, the number of the plurality of recesses 60 is different depending on the product size.

Preferably, the opening shape of the recesses 60 is a rectangle. The length of the rectangle is 5 mm˜10 mm. Preferably, the opening of the recesses 60 is a square of 5 mm×5 mm.

Specifically, the depth of the recesses 60 is 10000 Å˜50000 Å, preferably, 32000 Å.

The method for manufacturing a CF substrate of the disclosure forms the plurality of recesses 60 in the non-display region of the CF substrate such that after an orientation film 50 is subsequently coated on the plurality of recesses 60, the orientation angle of the orientation film 50 can be directly measured at the plurality of recesses 60. It facilitates simplifying the method for measuring the orientation angle of the orientation film.

Referring to FIG. 4 and FIG. 5, based on the described method for manufacturing a CF substrate, the disclosure further provides a CF substrate, including a base substrate 10, a multilayer-stacked structural layer 20 disposed on the base substrate 10, and a flat layer 40 on the multilayer-stacked structural layer 20.

The base substrate 10 includes a display region and a non-display region disposed around the display region. An area corresponding to the non-display region includes a plurality of through holes 30 disposed in the multilayer-stacked structural layer 20. The plurality of through holes 30 is surrounded by the flat layer 40. The surface of the flat layer 40 corresponding to the plurality of through holes 30 forms a plurality of recesses 60.

Specifically, the base substrate 10 is a glass substrate.

Specifically, the multilayer-stacked structural layer 20 includes at least a first structural layer 21 disposed on the base substrate 10 and a second structural layer 22 disposed on the first structural layer 21. The first structural layer 21 and the second structural layer 22 are any combination of a black matrix and a color photoresist layer.

In the multilayer-stacked structural layer 20, each structural layer 20 includes via holes 25 corresponding to each other such that the via holes 25 of the multilayer-stacked structural layer 20 are connected to each other to form the through holes 30.

Specifically, the flat layer 40 is a transparent organic material.

Specifically, the number of the plurality of recesses 60 is different depending on the product size.

Preferably, the opening shape of the recesses 60 is a rectangle. The length of the rectangle is 5 mm˜10 mm. Preferably, the opening of the recesses 60 is a square of 5 mm×5 mm.

Specifically, the depth of the recesses 60 is 10000 Å˜50000 Å, preferably, 32000 Å.

The CF substrate of the disclosure arranges the plurality of recesses 60 in the non-display region of the CF substrate such that after an orientation film 50 is subsequently coated on the plurality of recesses 60, the orientation angle of the orientation film 50 can be directly measured at the plurality of recesses 60. It facilitates simplifying the method for measuring the orientation angle of the orientation film.

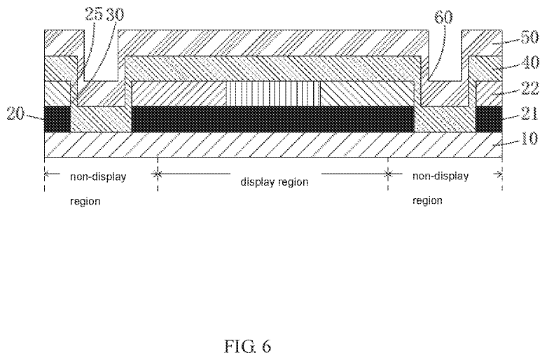

Referring to FIG. 6, the disclosure further provides a method for measuring the orientation angle of an orientation film, including: providing the CF substrate as described above; forming an orientation film 50 on the flat layer 40 of the CF substrate. The orientation film 50 covers the plurality of recesses 60. An orientation film measuring instrument is used to measure an orientation angle of the orientation film 50. The orientation film measuring instrument emits light to a portion of the orientation film 50 located in the recesses 60 and receives the reflected light. The orientation angle of the orientation film 50 is measured by using the principle of light reflection.

Since the flat layer 40 is disposed under the orientation film 50 at the plurality of recesses 60, the measurement of the orientation angle of the orientation film is prevented from being affected by the structural layers 20 such as a color photoresist layer and a black matrix. The flat layer 40 is transparent and has smooth surface. It has extremely small influence on the measured result of the orientation angle of the orientation film 50.

Specifically, the alignment film 50 is a light orientation film.

The method for measuring the orientation angle of the orientation film of the disclosure includes: forming the orientation film 50 on the described CF substrate, and directly measuring the orientation angle of the orientation film 50 at the plurality of recesses 60. Since the flat layer 40 is disposed under the orientation film 50 at the plurality of recesses 60, the measurement of the orientation angle of the orientation film 50 is prevented from being affected by structural layers such as a color photoresist layer and a black matrix, The flat layer 40 is transparent and has smooth surface. It has extremely small influence on the measured result of the orientation angle of the orientation film 50. Compared with the prior art, the disclosure does not need to reconstruct a measuring substrate. The method for measuring the orientation angle of the orientation film is simplified. The measurement accuracy is improved. Meanwhile, the real-time monitoring of the orientation angle of the orientation film in the fabrication process is realized. The batch products are prevented from defect.

In view of the above, the disclosure provides a CF substrate, a method for manufacturing the CF substrate, and a method for measuring the orientation angle of an orientation film. The method for manufacturing a CF substrate of the disclosure forms a plurality of recesses in the non-display region of the CF substrate such that after an orientation film is subsequently coated on the plurality of recesses, the orientation angle of the orientation film can be directly measured at the plurality of recesses. The CF substrate of the disclosure is manufactured by using the described method. It facilitates simplifying the method for measuring the orientation angle of the orientation film. The method for measuring the orientation angle of the orientation film of the disclosure includes forming the orientation film on the described CF substrate, and directly measuring the orientation angle of the orientation film at the plurality of recesses. Since a flat layer is disposed under the orientation film at the plurality of recesses, the measurement of the orientation angle of the orientation film is prevented from being affected by structural layers such as a color photoresist layer and a black matrix. The flat layer is transparent and has smooth surface. It has extremely small influence on the measured result of the orientation angle of the orientation film. Compared with the prior art, the disclosure does not need to reconstruct a measuring substrate. The method for measuring the orientation angle of the orientation film is simplified. The measurement accuracy is improved. Meanwhile, the real-time monitoring of the orientation angle of the orientation film in the fabrication process is realized. The batch products are prevented from defect.

For those skilled in the art, other various corresponding modifications and variations can be made according to the technical means and teachings of the disclosure as described above. The scope of the claims of the disclosure should encompass all these modifications and variations.

What is claimed is:

1. A method for manufacturing a color filter (CF) substrate, comprising the following steps:
a step 1, providing a base substrate, wherein the base substrate comprises a display region and a non-display region disposed around the display region;
forming a multilayer-stacked structural layer on the base substrate, wherein an area corresponding to the non-display region comprises a plurality of through holes disposed in the multilayer-stacked structural layer; and
a step 2, forming a flat layer on the multilayer-stacked structural layer and the base substrate, wherein the plurality of through holes is surrounded by the flat layer, and a surface of the flat layer corresponding to the plurality of through holes forms a plurality of recesses.

2. The method for manufacturing a CF substrate as claimed in claim 1, wherein the multilayer-stacked structural layer comprises at least a first structural layer disposed on the base substrate and a second structural layer disposed on the first structural layer, and wherein the first structural layer and the second structural layer are any combination of a black matrix and a color photoresist layer.

3. The method for manufacturing a CF substrate as claimed in claim 1, wherein in the step 1, a method for forming the plurality of through holes is, during the formation of the multilayer-stacked structural layer, forming a plurality of via holes in each structural layer, and the plurality of via holes corresponds to each other such that the plurality of via holes of the multilayer-stacked structural layer is connected to each other to form the plurality of through holes.

4. The method for manufacturing a CF substrate as claimed in claim 1, wherein an opening shape of the plurality of recesses is a rectangle, and a length of the rectangle is 5 mm˜10 mm.

5. The method for manufacturing a CF substrate as claimed in claim 1, wherein a depth of the plurality of recesses is 10000 Å˜50000 Å.

6. A color filter (CF) substrate, comprising a base substrate, a multilayer-stacked structural layer disposed on the base substrate, and a flat layer on the multilayer-stacked structural layer,
wherein the base substrate comprises a display region and a non-display region disposed around the display region, and an area corresponding to the non-display region comprises a plurality of through holes disposed in the multilayer-stacked structural layer, and wherein the plurality of through holes is surrounded by the flat layer, and a surface of the flat layer corresponding to the plurality of through holes forms a plurality of recesses.

7. The CF substrate as claimed in claim 6, wherein the multilayer-stacked structural layer comprises at least a first structural layer disposed on the base substrate and a second structural layer disposed on the first structural layer, wherein the first structural layer and the second structural layer are any combination of a black matrix and a color photoresist layer,
and wherein in the multilayer-stacked structural layer, each structural layer comprises a plurality of via holes corresponding to each other such that the plurality of via holes of the multilayer-stacked structural layer is connected to each other to form the plurality of through holes.

8. The CF substrate as claimed in claim 6, wherein an opening shape of the plurality of recesses is a rectangle, and a length of the rectangle is 5 mm˜10 mm.

9. The CF substrate as claimed in claim 6, wherein a depth of the plurality of recesses is 10000 Å˜50000 Å.

10. A method for measuring an orientation angle of an orientation film, comprising:
providing the CF substrate as claimed in claim 6;
forming an orientation film on the flat layer of the CF substrate, wherein the orientation film covers the plurality of recesses; and
using an orientation film measuring instrument to measure an orientation angle of the orientation film, wherein the orientation film measuring instrument emits light to a portion of the orientation film located in the plurality of recesses and receives a reflected light, and wherein the orientation angle of the orientation film is measured by using a principle of light reflection.
